(19) United States
(12) Patent Application Publication
(10) Pub. No.: US 2016/0298589 A1
(43) Pub. Date: Oct. 13, 2016

(54) SYSTEM AND METHOD FOR IMPROVED STARTING OF COMBUSTION ENGINE

(71) Applicant: Maxwell Technologies, Inc., San Diego, CA (US)

(72) Inventors: Ulf Carl Mikael Setterberg, La Jolla, CA (US); Jeremy Michael Cowperthwaite, San Diego, CA (US); Jeff Brakley, Carlsbad, CA (US)

(21) Appl. No.: 15/094,483

(22) Filed: Apr. 8, 2016

Related U.S. Application Data
(60) Provisional application No. 62/145,782, filed on Apr. 10, 2015.

(51) Int. Cl. F02N 11/08

(52) U.S. Cl. CPC F02N 11/0866; F02N 2011/0885; F02N 2200/063

(57) ABSTRACT

This disclosure provides systems, methods and apparatus for a combustion engine start system. In one aspect, the combustion engine start system includes a capacitor system and a controller configured to detect a battery voltage of an output of a battery system and receive an external input, wherein the controller is programmed to upon receiving the external input, if the battery voltage is below a first voltage threshold, connect an output of the capacitor system to the output of the battery system such that the battery voltage increases to a value that is at or above the first voltage threshold and below a second voltage threshold.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The present disclosure relates generally to systems and methods for providing a starting system for combustion engines. In particular, the systems and methods use a first energy storage system that provides greater power performance, such as a capacitor system, in combination with a second energy storage system that provides greater energy performance, such as a battery.

2. Description of the Related Art

Different mechanisms for starting a combustion engine exist. Many of these systems utilize the electrical energy stored in an energy storage system, for example batteries, to provide the initial energy necessary to start an engine. However, conventional systems do not provide efficient mechanisms for preventing depletion of the energy storage system beyond a level needed to restart the combustion engine.

### SUMMARY

The systems, methods and devices of this disclosure each have several innovative aspects, no single one of which is solely responsible for the desirable attributes disclosed herein.

One innovative aspect of the subject matter described in this disclosure can be implemented in a combustion engine start system. The combustion engine start system includes a capacitor system comprising one or more capacitors; a controller configured to detect a battery voltage of an output of a battery system and receive an external input, wherein the controller is programmed to: upon receiving the external input, if the battery voltage is below a first voltage threshold, connect an output of the capacitor system to the output of the battery system such that the battery voltage increases to a value that is at or above the first voltage threshold and below a second voltage threshold.

In one aspect, the controller is further programmed to connect the output of the capacitor system to the output of the battery system if an output current of the capacitor system is at or below a target current.

In one aspect, the controller is further configured to disconnect the output of the capacitor system from the output of the battery system if the output current of the capacitor system exceeds the target current.

In one aspect, the first voltage threshold is a minimum voltage required to power one or more critical loads connected to the battery system and needed to start an engine.

In one aspect, the combustion engine start system further includes: one or more low voltage disconnect units configured to disconnect one or more non-critical loads from the output of the battery system when the battery voltage is below the first voltage threshold.

In another aspect, the second voltage threshold is a charging voltage threshold of the battery system.

In some aspects, the controller is further programmed to disconnect the output of the capacitor system from the output of the battery system after a period of time.

In some aspect, the period of time is determined based on a state of charge of the capacitor system.

In one aspect, the controller is further configured to disconnect the output of the capacitor system from the output of the battery system if loads connected to the battery system draw an amount of current such that the battery voltage does not increase to a value at or above the first threshold.

In some aspects, the controller is further configured to generate an alert when disconnecting the output of the capacitor system and the battery system.

In some aspects, the external input is an engine start command received from an ignition key or a button on a dashboard of a vehicle.

In one aspect, the engine start system further includes: a charging circuit configured to connect the output of the capacitor system to the output of the battery system.

In another aspect, the controller is further programmed to: configure the charging circuit to supply an output current of the capacitor system to the output of the battery system if the battery voltage is below the first voltage threshold.

In one aspect, the controller is further programmed to configure the charging circuit to supply an output current of the battery system to the output of the capacitor system if an output voltage of the capacitor system is at or below a target value.

In one aspect, the charging circuit can include a bidirectional converter.

In some aspects, the bidirectional converter can include one or more of an H bridge, bidirectional buck-boost converter, two symmetric converters, or two converters.

In some aspects, the output current of the battery system is at or near an output current limit of the bidirectional converter.

Another innovative aspect of the subject matter described in this disclosure can be implemented in a method of starting a combustion engine. The method includes detecting a battery voltage of an output of a battery system; receiving an external input; and upon receiving the external input if the battery voltage is below a first voltage threshold, connecting an output of a capacitor system to the output of the battery system such that the battery voltage increases to a value that is at or above the first voltage threshold and below a second voltage threshold.

In some aspects, the method further includes: connecting the output of the capacitor system to the output of the battery system if an output current of the capacitor system is at or below a target current.

In some aspects, the method further includes: disconnecting the output of the capacitor system and the battery system if the output current of the capacitor system exceeds the target current.

In one aspect, the first voltage threshold is a minimum voltage required to power one or more critical loads connected to the battery system and needed to start an engine.

In one aspect, the method further includes: disconnecting loads other than critical loads from the output of the battery system when the battery voltage is at or below the first voltage threshold.

In some aspects, the second voltage threshold is a charging voltage threshold of the battery system.

In one aspect, the method further includes: disconnecting the output of the capacitor system and the battery system after a predetermined period of time lapses.

In one aspect, the method further includes determining the period of time based on a state of charge of the capacitor system.

In some aspects, the method further includes: disconnecting the output of the capacitor system from the output of the battery system if loads connected to the battery system draw an amount of current such that the battery voltage does not increase to a value at or above the first threshold.

In one aspect, the method further includes: generating an alert when disconnecting the output of the capacitor system and the battery system.

In some aspects, the method further includes: supplying an output current of the battery system to the output of the capacitor system if an output voltage of the capacitor system is at or below a target value.

In some aspects, connecting includes connecting the output of the capacitor system to the output of the battery system with a charging circuit.

In one aspect, the charging circuit can include a bidirectional converter.

In some aspects, the output current of the battery system is at or near an output current limit of the bidirectional converter.

In one aspect, the bidirectional converter can include one or more of an H bridge, bidirectional buck-boost converter, two symmetric converters, or two converters.

Details of one or more implementations of the subject matter described in this disclosure are set forth in the accompanying drawings and the description below. Although the examples provided in this disclosure are primarily described in terms of a vehicle system or an internal combustion engine system, the concepts provided herein may apply to other types of systems with or within which an energy storage system is implemented (e.g. generator). Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a system block diagram illustrating a combustion engine start system according to an embodiment.

FIG. 2 is a diagram illustrating an operational sequence of the combustion engine start system of FIG. 1 as utilized in a 12 V system.

FIG. 3 is flow diagram illustrating a method of operating a combustion engine start system according to an embodiment.

Like reference numbers and designations in the various drawings indicate like elements.

### DESCRIPTION

The electrical loads of a combustion engine system can be classified into two categories: critical and non-critical loads. In the context of the present disclosure, critical loads refer to those loads related to reliably starting a combustion engine, and to which an insufficient power supply will prevent the combustion engine from starting. These include, for example, the electronics and circuitry that provide electrical signaling to a starter circuit of the engine to start the engine, independent of the significant power needed to turn the starter itself. For example, in a vehicular context, if there is insufficient power to the dashboard, ignition switch, etc., the vehicle's engine may not start, even if there is sufficient power to the actual starter itself. Examples of critical loads in a vehicular context may include the engine control unit (ECU), ejector controller, engine computers and injectors. Non-critical loads can refer to auxiliary loads, for example, radios, fans or interior lights in the vehicle comprising the combustion engine. In a trucking context, some of the auxiliary loads are often referred to as “sleeper loads,” as these loads are often drawn when the truck operator is parked and asleep, with the combustion engine off.

The critical and non-critical loads may have different power requirements. Some loads, such as radios and fans, may require low and continuous power, while other loads, such as the starter of a combustion engine, can require high and instantaneous power to start or crank the engine. Combustion engine systems may include different types of energy storage systems to help provide the power requirements of the different types of loads. For example, batteries, ultracapacitors or asymmetric lithium capacitors can be designed to support various power loads. Some dual-energy storage systems may include a first energy storage system designed for improved power performance, such as a capacitor system, with a second energy storage system designed for improved energy performance, for example a battery system to provide electrical power to the vehicle. The capacitor system can include one or more capacitors, and the battery systems can include one or more batteries, wherein pluralities of capacitors or batteries are arranged into a bank, or set. Embodiments may include systems and methods for managing the efficient operation of a device that can provide capacitor and/or battery-based power to a vehicle, such as a car or truck. The system can include a device that includes one or more batteries and capacitors in one integrated unit that can be mounted into a car or truck or implemented with a generator or other combustion engine. The integrated unit may provide charging power to the vehicle by connecting to the starter of the vehicle. Some dual-energy storage systems include a capacitor that is implemented with the battery, to improve starter performance, such as those described further below.

For a combustion engine, a concern is that non-critical loads can discharge the energy storage systems of the engine to a level such that no electrical energy remains to power the critical loads and restart the engine. For example, it is common for a truck operator to sleep in the truck, with the engine and alternator off, and thus without regeneration to the truck battery system, but with other battery loads on, such as the exterior lights, air conditioning, computer power, etc. Upon the operator waking up, the voltage in the battery system may be below a voltage level needed to power the critical loads. For example, even in a combustion engine system that uses both a capacitor system and a battery system, the noncritical loads can drain the batteries to a level below an amount to sufficiently power the critical loads. In such a case, the combustion engine may not be restarted, even if a fully charged capacitor bank is available. For example, the critical loads may not have sufficient power to provide a signal that allows the energy stored in the capacitor bank to be used to restart the combustion engine. A typical voltage for correct operation of critical loads in a 12-Volt system is approximately 9 Volts (V).

To mitigate the aforementioned problems of system discharge through improper use of non-critical loads, two separate electrical distribution networks along with two separate energy storage systems can be provided, one for each category of loads, such that energy usage of one category has limited effect on the energy usage on another category. In such a design, even if non-critical loads reduce, or completely discharge their corresponding energy storage system, the critical loads still have their own corresponding separate energy storage system to signal and restart the combustion engine.

In other implementations, a combustion engine start system can be provided that has two separate energy storage systems, but without complete isolation of the two systems between critical and noncritical loads. Instead, the two energy storage systems can be selectively isolated from the critical or non-critical loads under certain conditions, such as when the combustion engine is off or when target voltage levels are detected. Such systems can provide additional power to the critical loads, and improve engine start reliability, without requiring completely separate electrical distribution networks for the two separate energy storage systems. Such systems can be simpler, less expensive, and be easier to retrofit than some other designs.

In some embodiments, the systems herein may include a controller configured to provide the functionality described herein. Embodiments of the invention described herein can include any of a number of different software, hardware, firmware, electronic circuits, controllers, computers (including hand-held computing devices), microchips, integrated circuits, printed circuit boards, and/or other microelectronic component known or described herein, or combinations thereof, and methods related thereto, suitable to provide the functionality described herein. Additionally, the functionality described herein for managing a capacitor system can be provided through any suitable electronic, mechanical, pneumatic, hydraulic, and/or other components and/or systems, or combinations thereof, or methods related thereto.

The components and/or systems described herein can be separately or integrally formed with the capacitor system. In some embodiments, the components and/or systems can be implemented with a plurality of capacitors batteries that form a capacitor or battery “bank.” The capacitors or batteries within these banks can be connected in series, in parallel, or in any matrix combination of capacitors connected in series and in parallel. The specific quantity of capacitors, batteries, or other components described in the systems herein, is for illustrative purposes only. Additionally, although the embodiments of the systems and methods for managing a capacitor system are described herein in a vehicular context, such as a commercial truck, they are not limited to any particular type of vehicle, vehicles in general, or any particular type of system.

Some embodiments of the engine start systems described herein can be configured to interact with and/or provide functionality to additional or alternative systems than a capacitor or commercial truck system. For example, the embodiments of the engine start systems herein can be implemented with or within other systems that use an internal combustion engine, such as boats or cars. Embodiments of the engine start systems described herein can be implemented with or within a non-vehicular system that uses a capacitor or battery system, such as a power generator for producing electricity. In some embodiments, the engine start systems can be implemented in combination with an internal combustion engine system which may include an engine, an alternator, a battery system and/or a starter system. Some embodiments can be configured to be used as a drop-in replacement for one or more batteries in a vehicular battery system, such as a Battery Council International (BCI) Group 31 or other sized battery. For example, the system can fit within a space envelope of approximately 330 mm length, approximately 173 mm wide, and approximately 240 mm high (including the terminals). In some embodiments, the energy storage systems described herein can be configured to provide a capacitance between a range of approximately 200 farads to approximately 2500 farads, or more narrowly, between a range of approximately 300 farads to approximately 1000 farads, or more narrowly, between a range of approximately 500 to approximately 1000 farads. In some embodiments, the energy storage systems described herein can be configured to provide a capacitance of approximately 1000 farads. In some embodiments, the energy storage systems described herein can be configured to provide a capacitance up to 7000 farads, or even more, for example, when implemented within some military vehicles or other vehicles with large power specifications.

The systems and methods described herein can be implemented within power systems configured for different operational voltages, such as 6 volt systems, 12 volt systems, 24 volt systems, 36 volt systems, 48 volt systems, and other operating system voltages. In some embodiments, the systems and methods described herein can be implemented within systems with an operating voltage typical of a vehicle or internal combustion engine system.

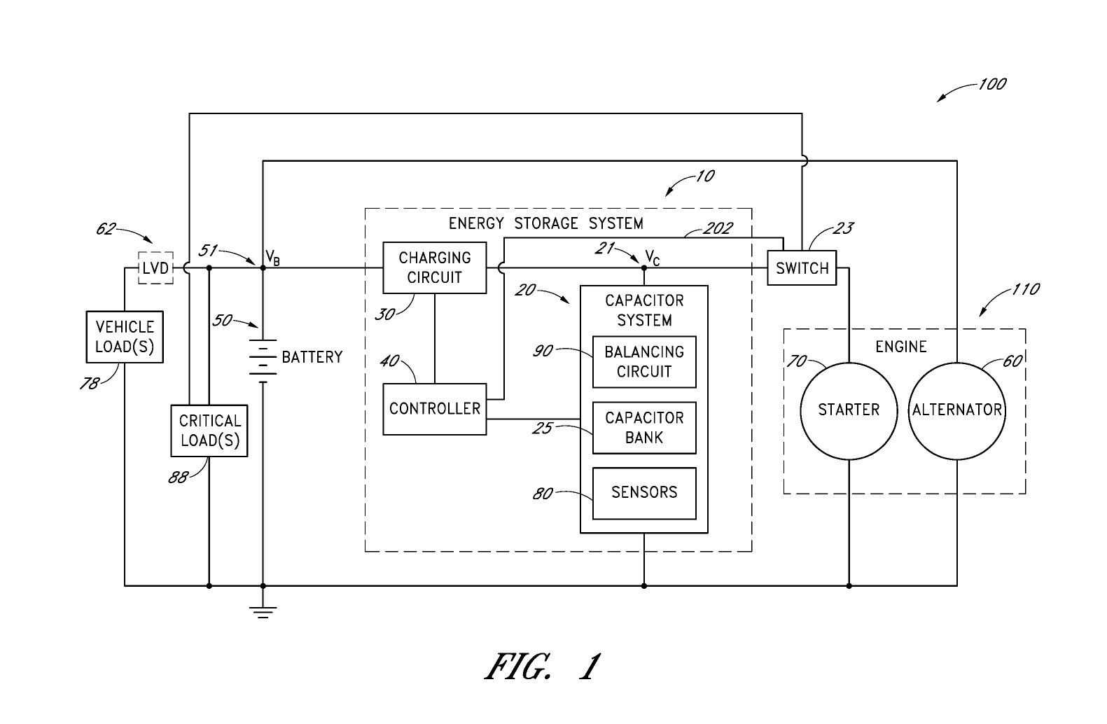

FIG. 1 is a system block diagram illustrating an internal combustion engine start system 100 with an energy storage system 10 according to an embodiment. The energy storage system 10 can include a capacitor system 20 comprising one or more capacitors. In the illustrated embodiment, the capacitor system 20 comprises a capacitor bank 25 having a plurality of capacitors. The capacitor system 20 can be configured to power a starter 70, which is configured to crank and start an internal combustion engine 110. A control switch 23 can be positioned between the capacitor system 20 and the starter 70, to allow selective electrical communication between the capacitor system 20 and the starter 70. Examples of the interaction between the control switch 23 and the remainder of system 10 are provided further below. The engine start system 100 can include an alternator 60 configured to charge a battery 50 and/or the capacitor bank 25, for example, through a battery terminal 51, when the engine 110 is on. The battery 50 can optionally be connected to the starter 70 through a control switch, such as switch 23, or a different switch, to provide optional, selective power for starting the engine 110. The energy storage system 10 can include a charging circuit 30, controlled by a controller 40 (or other controller) configured to selectively connect the capacitor system 20 with the battery 50 at the battery terminal 51, and provide additional functionality described herein.

There may be some advantages to starting engine 110 with the energy storage system 10, because the capacitor system 20 may perform better than comparable battery systems under some conditions. For example, capacitors may hold a charge better, have improved cycle life, provide a quicker charge and discharge time, and have more efficient charge acceptance than a comparable battery. Capacitors may also provide better starter performance at some temperatures, such as a cold-start application. For example, some embodiments of the energy storage system 10 described herein can include the capacitor system 20 with enough energy and power to cold start a 9.0 to 16.0L diesel engine unassisted at approximately −18° C., or even at temperatures as low as −40° C. or lower.

The energy of the battery 50 can be provided via the battery terminal 51 to two categories of loads: critical loads 88, and non-critical loads 78 which are shown in the example context of an engine start system of the vehicle as vehicle load(s) 78. In some embodiments, the vehicle loads 78 may correspond to any auxiliary or non-starting loads when the engine start system is implemented in non-vehicular systems (e.g., generators, industrial motors, etc.). The capacitor system 20, as described above, can also be connected to the battery terminal 51 via the charging circuit 30. The non-critical loads 78 can optionally be connected to the battery terminal 51 via one or more low voltage disconnect units 62. The low voltage disconnect 62 can protect the battery 50 or the capacitor system 20 from losing too much power to the non-critical loads 78 by disconnecting the non-critical loads 78 if the voltage of the battery terminal 51 drops below a minimum voltage.

The charging circuit 30 can be configured to receive power from the battery 50 and/or the alternator 60, and output a current to charge the capacitor bank 25 of capacitor system 20. The charging circuit 30 can be configured to provide an output current from the capacitor system 20 to the battery 50 via the battery terminal 51. The charging circuit 30 can be connected to the capacitor system 20 along a capacitor terminal 21, and can charge the capacitor system 20 to a target capacitor output voltage V_{c}.

The charging circuit 30 can comprise a DC to DC converter, such as a Single Ended Primary Inductance Converter (SEPIC), a boost converter, a buck-boost converter, a current-limiting resistor, a diode, or any other suitable device for selectively charging a capacitor from a power source, as described herein or known in the art. The charging circuit 30 can further comprise a bidirectional DC to DC converter, a bidirectional buck-boost converter, a symmetric converter, an H bridge or two converters used in parallel. Any of these charging circuits can be controllable so that the desired charging and/or discharging output voltage or current to and from the capacitor system 20 and/or the battery 50 can be achieved.

In some embodiments, the charging circuit 30 can provide controlled current and/or voltage from the battery 50 to the capacitor system 20 or from the capacitor system 20 to the battery 50. In other words, the charging circuit 30 can be configured to control, manipulate or maintain target level values for current and/or voltage both at the battery terminal 51 and at the capacitor terminal 21 thereby controlling the flow of current to and from the battery 50 and the capacitor system 20 and/or simultaneously control the voltage of the battery 50 at the battery terminal 51 and the voltage of the capacitor system 20 at the capacitor terminal 21. Some such control of current and/or voltage can be implemented to mitigate the problems of system discharge through improper use of non-critical loads and improve engine start reliability, as described further below.

In some embodiments, the charging circuit 30 can be implemented with four error amplifiers corresponding respectively to an input voltage, input current, output voltage and output current of the charging circuit 30. The charging circuit 30 can utilize feedback to accomplish its functions. For example, the charging circuit 30 can be configured to operate in constant voltage (CV) mode on the battery side and constant current (CC) mode on the capacitor side to preserve the energy stored in the capacitor system 20 while preventing the voltage at the battery terminal 51 to rise above a charging voltage threshold of the battery 50 as will be further described below. Other modes of operation for the charging circuit 30 are also possible depending on the desired function.

Various system parameters can determine what values of current and voltage are desired at both ends of the charging circuit 30. For example, in some implementations, the battery 50 can draw a large current, such as 300 to 400 amps (A), thereby, quickly discharging and depleting the energy stored in the capacitor system 20. In this scenario, when providing power from the capacitor system 20 to the battery 50, the charging circuit 30 can be configured to limit the current drawn from the capacitor system 20 to a smaller value, such as only 2 to 3 amps, to provide enough power to run the critical loads while preventing the capacitor system 20 from discharging quickly into the battery 50.

When providing energy from the battery terminal 51 to the capacitor system 20, the charging circuit 30 can be configured to run in constant current to constant voltage (CCCV) mode. As an example, in a 12 V system and at room temperature, the charging circuit 30 can provide a constant current of 10 A to the capacitor system 20 until the voltage of the capacitor terminal 21 reaches 15 V. The charging circuit 30 then can reduce or stop the supply of current to the capacitor system 20, maintaining the voltage of the capacitor terminal 51 at 15 V.

When providing energy from the capacitor system 20 to the battery terminal 51 or the battery 50, the charging circuit 30 can be configured to run in constant voltage (CV) mode with an upper current limit. For example, in a 12 V system, the charging circuit 30 can be configured to supply a current from the capacitor system 20 to the battery terminal 51 such that the battery terminal 51 is at or near a constant voltage, for example 9.5 V with an upper current limit of 2 to 3 amps. The upper current limit can be designed based on various parameters of the engine start system 100 of FIG. 1, for example, the size and capacity of the capacitor system 20 relative to the size and capacity of the battery 50 as well as the current or voltage demands of each.

The control of charging circuit 30, and other functionality within the energy storage system 10 can be provided by a controller 40. For example, the controller 40 can manage the aforementioned transfer of energy through the charging circuit 30. While not shown, an additional dedicated controller can be be included to communicate with the controller 40 and control the operations of the charging circuit 30. In some embodiments, the energy storage system 10 can include a voltage sensor configured to detect the capacitor output voltage V_{c} and provide voltage feedback to an operator, the controller 40, or another component or system. In some embodiments, the voltage feedback from the voltage sensor can allow for the user or controller to take an action, such as adjusting the target voltage. Additionally, the controller 40 can be configured to detect or monitor the voltage of the battery 50 at battery terminal 51 as well as the voltage of the capacitor terminal 21.

In some embodiments, the capacitor system 20 can include a balancing circuit 90 configured to manage the voltage of individual capacitors within a capacitor bank relative to each other and the overall capacitor output voltage V_{c}. The balancing circuit 90 can “balance” or reduce the differences between the voltages of the individual capacitors. Such balancing can avoid certain capacitors being charged to a higher or lower voltage than other capacitors, which can have an impact on the service life of the capacitor system 20. In some embodiments, balancing circuit 90 can be configured to allow the overall capacitor output voltage V, to be reduced from a first target voltage to a second target voltage, as described further herein. The balancing circuit 90 can include a number of different configurations, using wires, printed circuit boards, and the like.

The controller 40 can be in communication with the charging circuit 30, the capacitor system 20, and other components and systems to provide additional functionality to energy storage device 10. For example, controller 40 can be configured to detect one or more conditions relevant to the capacitor system 20, determine whether the capacitor system 20 should be operated in a degraded state in response to the condition, and take an action based upon the condition detected. For example, such controller 40 can be configured to provide such functionality related to other power source systems such as batteries 50 and alternator 60 and other systems.

The controller 40 can detect a condition within the systems described herein using any of a variety of sensing devices and methods. Such sensing devices and methods can be configured to detect a condition relevant to the capacitor system 20. The sensing devices can be positioned within, on, proximate to, or even external to, capacitor system 20, and still detect a condition relevant to capacitor system 20. For example, sensing devices can be configured to detect the output voltage V_{c}, as described above, or the temperature of and pressure within the capacitors of the system 20, or conditions within the balancing circuit 90. In some embodiments, sensing devices can be configured to detect a condition that is external to, but may still impact the performance of, the capacitor system 20, such as the battery voltage V_{b}, and the condition of the charging circuit 30.

In some embodiments, the capacitor system 20 can include one or more sensors 80 configured to detect a condition relevant to the capacitor system 20 and provide an input to the controller 40. The sensors 80 can be positioned within, on, proximate to, or external to the capacitor system 20. The sensors 80 can include any of a number of different monitoring devices or systems suitable to detect any of a number of different conditions, and communicate the condition to the controller 40. For example, the sensors 80 can comprise voltage sensors, capacitance sensors, current sensors, temperature sensors, pressure sensors, and/or other sensors to detect other conditions.

The input to controller 40 of a condition detected by one or more of the sensors 80 can be evaluated by controller 40 to determine whether the condition is related to the capacitor system 20. Such evaluation can be based upon a comparison of the condition to a programmed setpoint or previously detected condition, such as a difference between the condition and the setpoint, or a more complex algorithm. Any of a number of different detected conditions may be used, and any of a number of actions can be taken in response.

It may be beneficial to maintain the voltage V_{b} of battery 50 within a range that reduces discharge from the capacitor system 20, while still providing sufficient voltage to power the critical loads 88. For example, battery systems such as battery 50 have an open circuit or nominal voltage. For example, in a 12 V system, the open circuit or nominal battery voltage of the battery 50 can be approximately 12 V. Ordinarily, a voltage above this open circuit voltage is needed to reverse the chemical reactions inside a battery and start charging the battery. This voltage, above which a battery system can start charging, may be defined as the charging voltage threshold of the battery system. For example, in a 12 V system, where the nominal battery voltage of a battery is 12 V, the battery may start charging when 13 V is provided to its terminals or may start to optimally charge when 14 V or more is provided to its battery terminals. For voltages below this charging voltage threshold, the battery to does not draw much current because the charging of the battery is minimal. The charging voltage threshold of a battery can depend on factors including battery type, temperature, state of charge of the batteries (SOC), state of health of the batteries (SOH) and chosen charge cycle for the batteries. Thus, it can be beneficial at some times, to maintain the voltage of the battery 50 below its charging voltage threshold to prevent the capacitor system 20 from being discharged through its charging of the battery 50.

Additionally, the critical loads 88 can be adequately powered to start the vehicle, provided they are supplied with a voltage that is above a minimum critical load voltage. For example, in a 12 V system, the minimum voltage to allow a critical load to start a vehicle may be approximately 9 V. Thus, it may be advantageous to control the battery voltage V_{b} to be within a range below the aforementioned charging voltage threshold of the battery 50, and above the minimum voltage to power the critical load 88 of these engine start systems 100. For example, in a 12 V system, this range falls between 9 V to 12 V. Therefore, if the critical loads 88 are connected to the battery 50 and supplied with a voltage from capacitor system 20 that falls within this range, the voltage will be sufficient to adequately power the critical loads 88, but at the same time the stored capacitor energy will not be depleted through charging of the battery 50. The critical loads 88, once powered, can use the remaining energy stored in the capacitor system 20 to carry out an engine start sequence or crank.

The charging circuit 30 can be utilized in combination with the controller 40 or its own dedicated controller to maintain the voltage at the battery terminal 51 below the aforementioned charging voltage threshold of the battery 50 but above a minimum voltage needed to operate the critical loads 88. The charging circuit 30 can also be configured to connect the capacitor system 20 to the battery terminal 51 only if the output current demands of the non-critical loads 78 are below a target or an upper limit current. This can prevent a situation where the non-critical loads 78 draw a significant amount of current from the capacitor system 20 draining the capacitor bank 25.

As described above, the charging circuit 30 in combination with the controller 40 or its own dedicated controller can be configured to be able to monitor voltages of both the battery 50 and the capacitor system 20. Additionally, the charging circuit 30 in combination with the controller 40 or its own dedicated controller can be configured to monitor the currents to and from the battery 50 as well as the current to and from the capacitor system 20. The charging circuit 30 can also control the charging and/or discharging of the battery 50 and/or the capacitor system 20 in order to maintain a desired current or voltage at the capacitor terminal 21 or the battery terminal 51. The charging circuit 30 can, for example, be implemented using a bidirectional DC to DC converter, a bi-directional buck-boost converter, symmetric converters, H bridges or two converters used in parallel. .

The controller 40 can be configured to receive an external input, for example a signal that an engine start command is imminent. This external input can be generated manually for example when an operator of the engine start system 100 depresses a push button, or can be generated by wireless connection technology. The external input can also be generated automatically when an operator turns an ignition key. The external input can also be controlled by an engine controller using conventional wired I/O connections or controlled by an engine controller using serial communication. Examples of serial communication can include utilizing CAN or LIN protocols.

In some embodiments, the ignition key (not shown) and its associated circuitry can be part of the critical loads 88. The critical loads 88 can also include a drive relay or switch (not shown). The drive relay or switch in conjunction with the ignition key can signal the closing of the switch 23 to engage a starter 70. In some embodiments turning the ignition key to a first position can trigger a start-up sequence, such as a vehicle start-up sequence. The start-up sequence can include powering up an ECU (not shown), checking critical functions of the engine, for example, a brake system, pressure or other functions related to safety or other engine specific functions. In some applications, the start-up sequence can include starting pre-heaters or other functions related to starting up a combustion engine system. In some implementations, when the start-up sequence is successfully concluded, a notification to the operator can be generated. The ignition key can be turned into a second position signaling the switch 23 to close and engage the starter 70. In some embodiments, the start-up sequence can be carried out by the critical loads 88 and may not function properly if the critical loads 88 are not properly powered.

As will be described in more detail below, in some embodiments, the voltage of the battery 50 can be monitored. When the ignition key is in the first position as described above and if the voltage of the battery 50 is below the voltage needed to properly operate the critical loads 88, the controller 40 can provide power from the capacitor system 20 to the battery terminal 51, thereby powering the critical loads 88 to carry out their functions, for example, the start-up sequence as described above. When these functions are concluded, a notification can be provided, and the ignition key can be turned into the second position signaling the switch 23 to close and engage the starter 70.

In some embodiments, upon receiving an external input from a control dashboard or automatically from an ignition key as described above and if the controller 40 detects that the battery 50 is depleted to a level that it cannot provide enough power to the critical loads 88, the controller 40 can configure the charging circuit 30 to provide power to the battery terminal 51 and consequently to the critical loads 88. The controller 40 can for example detect the voltage of the battery terminal 51 upon receiving the external input. If the detected voltage of the battery terminal 51 is below a voltage threshold, the controller 40 can cause the capacitor terminal 21 to be connected to the battery terminal 51, for example, through charging circuit 30. This allows a current to be provided via terminal 51 (and indirectly via terminal 21) to the critical loads 88.

The controller 40 can provide this current to the battery terminal 51 while preventing unnecessary discharge of the capacitor system 20. For example, the controller 40 can connect the capacitor system 20 to the battery terminal 51 such that the battery voltage of the battery 50 increases to a value that is at or above a first voltage threshold and below a second voltage threshold. The first voltage threshold can be a minimum voltage required to power one or more critical loads 88 needed to start an engine. The second voltage threshold can be the aforementioned charging voltage threshold of the battery 50 above which the battery 50 begins to charge, drawing a significant amount of current.

As described above, upon receiving an external input, for example an engine start signal, if the voltage of the battery 50 is below the first voltage threshold, the controller 40 can configure the charging circuit 30 to operate in a constant voltage mode supplying energy from the capacitor system 20 to the battery terminal 51, such that the battery voltage of battery 50 increases to a value that is at or above the first voltage threshold and below the second voltage threshold. The constant voltage can be a voltage at or above the first voltage threshold and below the second voltage threshold.

In a 12 V system, where the open circuit voltage of the battery 50 is 12 V, the controller 40 can configure the charging circuit 30 to provide a constant voltage between 9 V to 12 V preferably 9 or 9.5 V to the battery terminal 51 in order to power the critical loads 88 but prevent depleting the capacitor bank 25 by sinking current into charging the battery 50. In this scenario, the first voltage threshold can be 9 V and the second voltage threshold can be 12 V.

Furthermore, to preserve the energy stored in the capacitor system 20, the controller 40 can also be programmed to connect the output 21 of the capacitor system 20 to the output 51 of the battery 50 only if the output current of the capacitor system 20 is at or below a target current. The target current can be chosen based on system parameters to provide enough current to power the critical loads 88 while preventing the depletion of the capacitor system 20 through the non-critical loads 78 which may still be connected. In a 12 V system, the target current can be chosen to be 2 or 3 amps. Other values are also possible depending on a particular implementation of the engine start system 100. Therefore, the controller 40 can also be programmed or configured to disconnect the output 21 of the capacitor system 20 from the output 51 of the battery 50 if the output current of the capacitor system 20 exceeds the target current.

Additionally, to prevent or reduce the chance of unnecessary depletion of the capacitor system 20, the controller 40 can configure the charging circuit 30 to disconnect the capacitor system 20 from the battery terminal 51, and thus from battery 50, after a predetermined period of time. The predetermined amount of time can be the period of time required for the critical loads 88 to power up and carry out an engine start sequence. An exemplary range of values for the predetermined amount of time is 5 seconds to 5 minutes. Alternatively, the predetermined amount of time can be determined based on the SOC of the capacitor bank 25. For example, if the capacitor bank 25 is already at a low SOC prior to it being connected to the battery 50, the period of time may be decreased, to avoid overly depleting the capacitor bank 25. If the capacitor bank 25 is at a high SOC prior to it being connected to the battery 50, the period of time may be greater.

The period of time prior to which the controller 40 disconnects the capacitor system 20 from the battery terminal 51 can also be determined partly based on ambient temperature. In colder climates, more energy is required for cranking or starting the engine 110, therefore, the predetermined period of time may be shorter in order to maintain more energy of the capacitor bank 25 for an engine cranking or starting event. In other words, in colder climates the tolerance for how much the controller 40 discharges the capacitor bank 25 is lower, conserving more energy for the cranking event.

In some circumstances, even if the capacitor system 20 is connected to the battery 50, the capacitor system 20 may not be able to increase the voltage of battery 50 to be above the first desired threshold. For example, one or more non-critical loads 78 connected to the battery 50 might still be on and thus drawing current during a period of support when the charging circuit 30 is providing the energy of the capacitor bank 25 to the battery terminal 51. In this scenario, the current output from the battery terminal 51 can reach a maximum threshold while the voltage at the battery terminal 51 has not reached the voltage threshold needed to power the critical loads 88. The controller 40 can detect this situation when monitoring the current and/or voltage at the battery terminal 51 and signal the charging circuit 30 to disconnect the capacitor system 20 from the battery terminal 51 in order to preserve the energy stored in the capacitor bank 25.

When the capacitor system 20 and battery 50 are disconnected, an alert via an error or warning message can then be issued to the operator of engine start system 100 to alert the operator of the system disengagement. The operator can then investigate which loads might be still drawing a significant current from the battery terminal 51 not allowing the voltage of the battery terminal 51 to rise above a minimum voltage needed to support the critical loads 88. For example, a heating blanket, a non-critical load, can still be on and connected attempting to draw a significant current from the battery terminal 51. The operator can disconnect this load and reengage the engine start system 100. Such warning might be communicated to an operator using, for example, digital means such as an I/O signal or via serial communication, or through visual means such as LED or messages on a display.

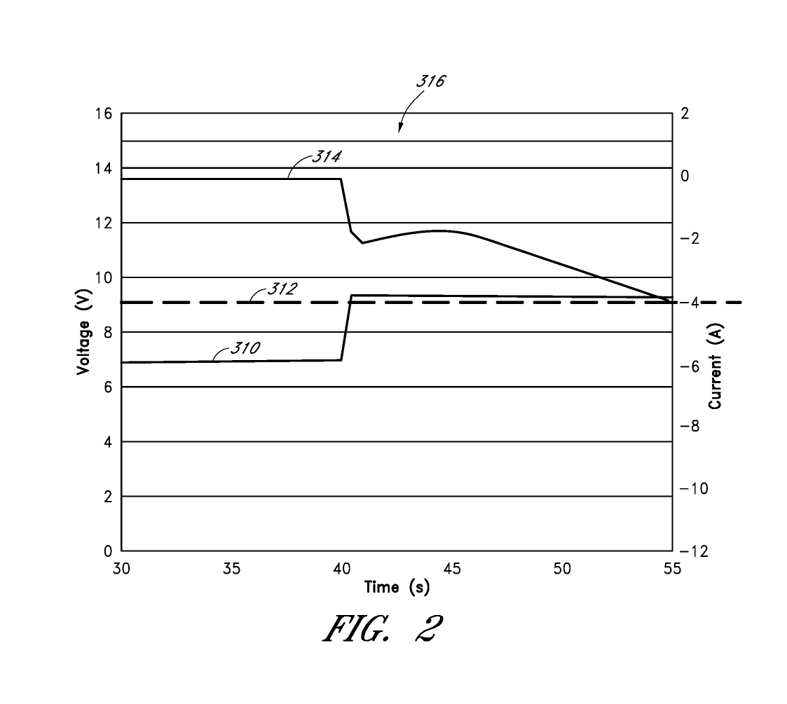

FIG. 2 is a diagram illustrating an operational sequence of the combustion engine start system of FIG. 1 as utilized in a 12 V system. Time in seconds (s) is shown on the X axis. Voltage (V) is shown on the Y axis on the left and current in Amps (A) is shown on Y axis on the right.

Referring to both FIGS. 1 and 2, the line 310 shows the battery voltage of the battery 50 at the battery terminal 51. The line 312 shows the minimum voltage needed to correctly operate the critical loads 88. For an exemplary 12 V system, the line 312 hovers just above 9 V. The line 314 shows a current provided from the capacitor system 20 to the battery terminal 51. The line 316 shows a voltage available at the capacitor system 20 at different points in time.

From the time 30 to 40 seconds, the battery 50 is depleted and therefore the voltage at the battery terminal 51 is well below what is needed to power the critical loads 88. At time 40 seconds, an external input, for example an engine start command is received. In response, the controller 40, detecting the low voltage condition of the battery 50, configures the charging circuit 30 to provide current, as shown by line 314, to the battery terminal 51. As shown by line 310, after the time 40 seconds, the voltage of the battery terminal 51 rises above the line 312 due to the current provided from the capacitor system 20. The current 314 provided to the battery 50 increases in the negative direction, indicating that the direction of the current flow is from the capacitor system 20 to the battery terminal 51. The charging circuit 30 can be configured to operate in constant voltage mode maintaining the voltage 310 at a constant value just above the line 312. The voltage available at the capacitor system 20 drops slightly below 15 V due to the current drawn from the capacitor system 20. In the example shown in FIG. 2, if a 1000 farads (F) capacitor system 20 is used, and the capacitor system 20 provides 3 amperes (A) to the battery terminal 51 over 15 seconds, then the voltage of the capacitor system 20 drops below its initial 15 V by approximately 3×15/1000 or 0.045 V. For the scale used in the graph of FIG. 2, the line 316 (the voltage of the capacitor system 20) is shown as a nearly horizontal line. However, as the calculation above shows, the capacitor system 20 experiences a slight voltage drop when providing power to the battery terminal 51.

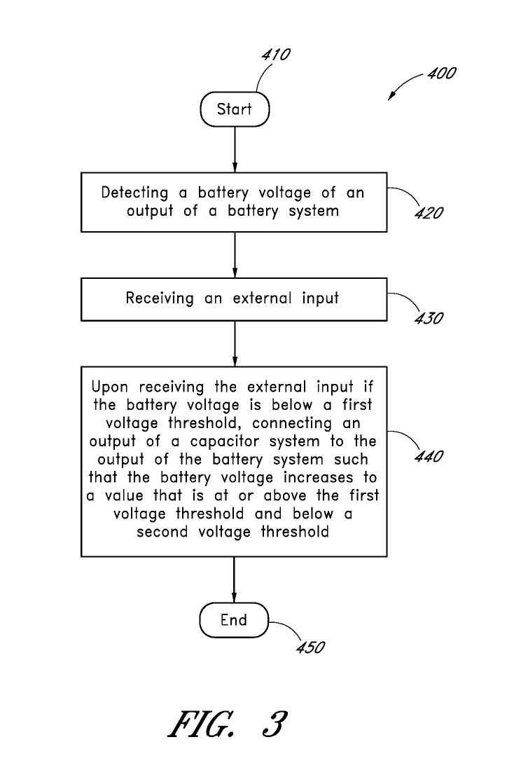

FIG. 3 is a flow diagram illustrating a method 400 of operating a combustion engine start system according to an embodiment. Method 400 can be implemented, for example, using the combustion engine start system 100 illustrated in FIG. 1. The method 400 starts at block 410. The method then continues at block 420 by detecting a battery voltage of an output of a battery system. The process 400 then moves to block 430 by receiving an external input. Upon receiving the external input, the method then moves to the block 440 and if the battery voltage is below a first voltage threshold, the method continues by connecting an output of a capacitor system to the output of the battery system such that the battery voltage increases to a value that is at or above the first voltage threshold and below a second voltage threshold. The process then ends at block 450.

In some implementations, process 400 further includes connecting the output of the capacitor system to the output of the battery system if an output current of the capacitor system is at or below a target current. In some implementations, process 400 further includes disconnecting the output of the capacitor system and the battery system if the output current of the capacitor system exceeds the target current. In some implementations, process 400 further includes supplying an output current of the battery system to the output of the capacitor system if an output voltage of the capacitor system is at or below a target value.

In some implementations, connecting includes connecting the output of the capacitor system to the output of the battery system with a charging circuit. In some implementations, the charging circuit comprises a bidirectional converter. In some implementations, the output current of the battery system is at or near an output current limit of the bidirectional converter. In some implementations, the bidirectional converter comprises one or more of H bridge, bidirectional buck-boost converter, two symmetric converters, or two converters.

In some implementations, the first voltage threshold is a minimum voltage required to power one or more critical loads connected to the battery system and needed to start an engine.

In some implementations, process 400 further includes disconnecting loads other than critical loads from the output of the battery system when the battery voltage is at or below the first voltage threshold.

In some implementations, the second voltage threshold is a charging voltage threshold of the battery system.

In some implementations, process 400 further includes disconnecting the output of the capacitor system and the battery system after a predetermined period of time lapses. In some implementations, process 400 further includes determining the period of time based on a state of charge of the capacitor system.

In some implementations, process 400 further includes disconnecting the output of the capacitor system from the output of the battery system if loads connected to the battery system draw an amount of current such that the battery voltage does not increase to a value at or above the first threshold. In some such implementations, process 400 further includes generating an alert when disconnecting the output of the capacitor system and the battery system.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, or other device. In the alternative, the processor and the storage medium may reside as discrete components in a user terminal, or other device.

The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

While the above description has pointed out novel features of the invention as applied to various embodiments, the skilled person will understand that various omissions, substitutions, and changes in the form and details of the device or process illustrated may be made without departing from the scope of the invention.

It will also be understood that although many of the embodiments herein describe the use of various components in combination to form embodiments of a system and method for managing operation of an engine start system, many of the components can be manufactured and provided independently without other components. For example, embodiments of the system and method for managing operation of an engine start system, and any of the many other components described herein, or any combination thereof, can be provided separately, and/or as a kit. Thus, the invention is not to be limited otherwise.

What is claimed is:

1. An engine start system, comprising:
a capacitor system comprising one or more capacitors; and
a controller configured to detect a battery voltage of an output of a battery system and receive an external input, wherein the controller is programmed to:
upon receiving the external input, if the battery voltage is below a first voltage threshold, connect an output of the capacitor system to the output of the battery system such that the battery voltage increases to a value that is at or above the first voltage threshold and below a second voltage threshold.

2. The engine start system of claim 1 wherein the controller is further programmed to connect the output of the capacitor system to the output of the battery system if an output current of the capacitor system is at or below a target current.

3. The engine start system of claim 2 wherein the controller is further configured to disconnect the output of the capacitor system from the output of the battery system if the output current of the capacitor system exceeds the target current.

4. The engine start system of claim 1 wherein the first voltage threshold is a minimum voltage required to power one or more critical loads connected to the battery system and needed to start an engine.

5. The engine start system of claim 1 further comprising: one or more low voltage disconnect units configured to disconnect one or more non-critical loads from the output of the battery system when the battery voltage is below the first voltage threshold.

6. The engine start system of claim 1 wherein the second voltage threshold is a charging voltage threshold of the battery system.

7. The engine start system of claim 1 wherein the controller is further programmed to disconnect the output of the capacitor system from the output of the battery system after a period of time.

8. The engine start system of claim 7 wherein the period of time is determined based on a state of charge of the capacitor system.

9. The engine start system of claim 7 wherein the controller is further configured to disconnect the output of the capacitor system from the output of the battery system if loads connected to the battery system draw an amount of current such that the battery voltage does not increase to a value at or above the first threshold.

10. The engine start system of claim 9 wherein the controller is further configured to generate an alert when disconnecting the output of the capacitor system and the battery system.

11. The engine start system of claim 1 wherein the external input is an engine start command received from an ignition key or a button on a dashboard of a vehicle.

12. The engine start system of claim 1 further comprising:
a charging circuit configured to connect the output of the capacitor system to the output of the battery system.

13. The engine start system of claim 12, wherein the controller is further programmed to:
configure the charging circuit to supply an output current of the capacitor system to the output of the battery system if the battery voltage is below the first voltage threshold.

14. The engine start system of claim 13 wherein the controller is further programmed to configure the charging circuit to supply an output current of the battery system to the output of the capacitor system if an output voltage of the capacitor system is at or below a target value.

15. The engine start system of claim 14 wherein the charging circuit comprises a bidirectional converter.

16. The engine start system of claim 15 wherein the bidirectional converter comprises one or more of H bridge, bidirectional buck-boost converter, two symmetric converters, or two converters.

17. The engine start system of claim 15 wherein the output current of the battery system is at or near an output current limit of the bidirectional converter.

18. A method of starting an engine system comprising:
detecting a battery voltage of an output of a battery system;
receiving an external input; and
upon receiving the external input if the battery voltage is below a first voltage threshold, connecting an output of a capacitor system to the output of the battery system such that the battery voltage increases to a value that is at or above the first voltage threshold and below a second voltage threshold.

19. The method of claim 18 further comprising:
connecting the output of the capacitor system to the output of the battery system if an output current of the capacitor system is at or below a target current.

20. The method of claim 19, further comprising disconnecting the output of the capacitor system and the battery system if the output current of the capacitor system exceeds the target current.

21. The method of claim 18 wherein the first voltage threshold is a minimum voltage required to power one or more critical loads connected to the battery system and needed to start an engine.

22. The method of claim 18 further comprising: disconnecting loads other than critical loads from the output of the battery system when the battery voltage is at or below the first voltage threshold.

23. The method of claim 18 wherein the second voltage threshold is a charging voltage threshold of the battery system.

24. The method of claim 18 further comprising: disconnecting the output of the capacitor system and the battery system after a predetermined period of time lapses.

25. The method of claim 24 further comprising determining the period of time based on a state of charge of the capacitor system.

26. The method of claim 18 further comprising: disconnecting the output of the capacitor system from the output of the battery system if loads connected to the battery system draw an amount of current such that the battery voltage does not increase to a value at or above the first threshold.

27. The method of claim 26 further comprising generating an alert when disconnecting the output of the capacitor system and the battery system.

28. The method of claim 18 further comprising supplying an output current of the battery system to the output of the capacitor system if an output voltage of the capacitor system is at or below a target value.

29. The method of claim18, wherein connecting comprises connecting the output of the capacitor system to the output of the battery system with a charging circuit.

30. The method of claim 29, wherein the charging circuit comprises a bidirectional converter.

31. The method of claim 30 wherein the output current of the battery system is at or near an output current limit of the bidirectional converter.

32. The method of claim 29 wherein the bidirectional converter comprises one or more of H bridge, bidirectional buck-boost converter, two symmetric converters, or two converters.
